(19) United States
(12) Patent Application Publication
(10) Pub. No.: US 2017/0338073 A1
(43) Pub. Date: Nov. 23, 2017

(54) CASING REPLACEABLE FUSE ASSEMBLY

(71) Applicant: Yue-Zhi Lin, Taichung City (TW)

(72) Inventor: Yue-Zhi Lin, Taichung City (TW)

(21) Appl. No.: 15/161,288

(22) Filed: May 23, 2016

(51) Int. Cl. H01H 85/32; H01H 85/56; H01H 85/175

(52) U.S. Cl. CPC H01H 85/32; H01H 85/175; H01H 85/56

(57) ABSTRACT

A fuse assembly includes a casing having two slots defined through the first end thereof, and a conductive member is located in the casing and has a first end extending through the second end of the casing. The conductive member includes two blades with a fuse connected therebetween. A cap is detachably mounted to the first end of the casing and has a light member connected thereto. The light member has a leg portion which is electrically connected to a second end of the conductive member. When the fuse is burned off, the light member lights on, the cap is removed from the casing, and is detachably connected to a new casing with a functional fuse therein.

### BACKGROUND OF THE INVENTION

### 1. Fields of the Invention

The present invention relates to a fuse assembly, and more particularly, to a casing replaceable fuse assembly, the casing can be individually replaced relative to the light member.

### 2. Descriptions of Related Art

The conventional fuse assemblies generally comprise a fuse which is made by low-melting material such as Lead-Tin alloy, copper, or Zinc, and the fuse is designed to be burned so as to cut off the circuit to protect the appliances. Therefore are many different shapes and types of fuses, and the fuses can be cataloged into Time-lag, Fast and Medium time-lag fuses so as to meet different requirements of use.

In order to acknowledge the users that the fuse is burned and the circuit is off, a light member is cooperated with the fuse. When an abnormal current is going to pass through the circuit of an appliance, the fuse is burned to protect the appliance and the light member lights on to acknowledge the users. This type of fuse arrangement can be often seen in vehicle fuses.

However, once the fuse is burned, the whole fuse assembly including the light member is replaced, although the light member is not damaged. The discarded light members become a burden of environmental protection.

The present invention intends to provide a fuse assembly wherein only the casing is replaced and the light member can be re-used.

### SUMMARY OF THE INVENTION

The present invention relates to a fuse assembly and comprises a casing which has two slots defined through the first end thereof. A conductive member is located in the casing and has a first end there extending through a second end of the casing. A cap has an open bottom which is detachably mounted to the first end of the casing. A light member is connected to the cap and has a bulb and a leg portion which is electrically connected to the bulb. The leg portion is electrically connected to a second end of the conductive member.

Preferably, the conductive member includes two blades which are located with a gap formed therebetween. A fuse is connected between the two blades.

Preferably, the casing has a room defined therein which communicates with the two slots. Two protrusions extend from the inside of the room. Each of the two blades has a hole, and the two protrusions are engaged with the two holes of the two blades.

Preferably, the leg portion of the light member has two legs, and the leg portion is electrically connected to the bulb. The two legs extend through the slots and are electrically connected to the two blades.

Preferably, the cap has at least one anti-slip face defined in the outside thereof.

The primary object of the present invention is to provide a fuse assembly wherein the cap with the light member can be reused, and only the casing is replaced. The light member is not discarded and re-used to protect the environment from being polluted by the discarded light members.

Another object of the present invention is to provide a fuse assembly wherein the two blades of the conductive member are well positioned by engaging the protrusions with the holes of the two blades.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the fuse assembly of the present invention;

FIG. 2 is a perspective view to show the fuse assembly of the present invention;

FIG. 3 is a cross sectional view to show the cap, the casing and the conductive member of the fuse assembly of the present invention;

FIG. 4 is a cross sectional view, taken along line IV-IV in FIG. 2, and

FIG. 5 is a cross sectional view to show that the light member lights on when the fuse is burned off.

### DETAILED DESCRIPTION OF THE PREFERRED EMBODIMENT

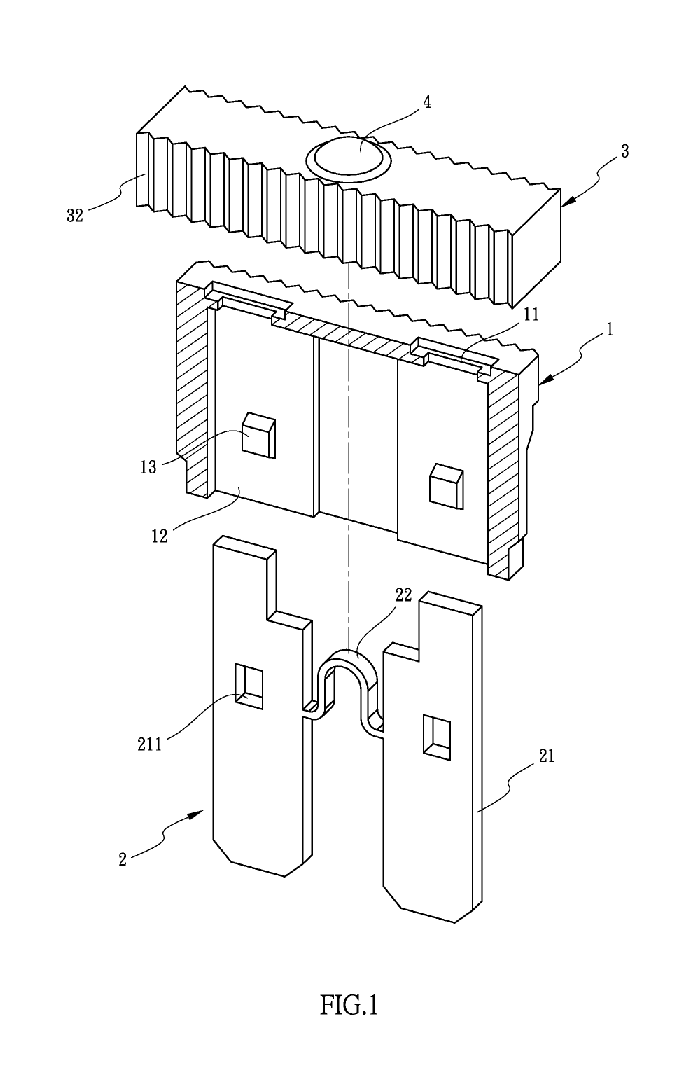

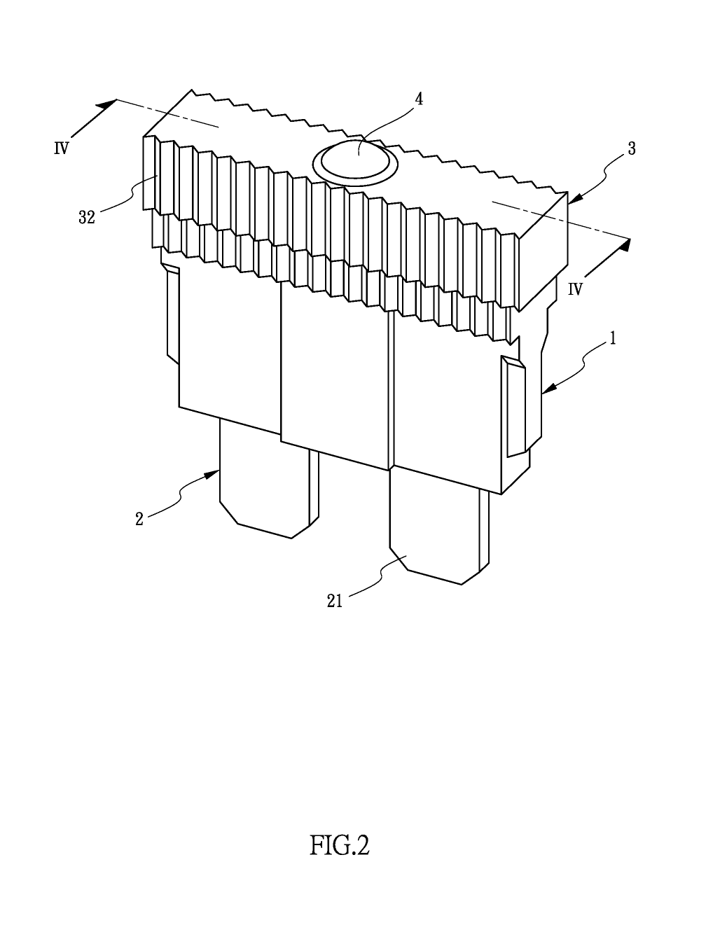

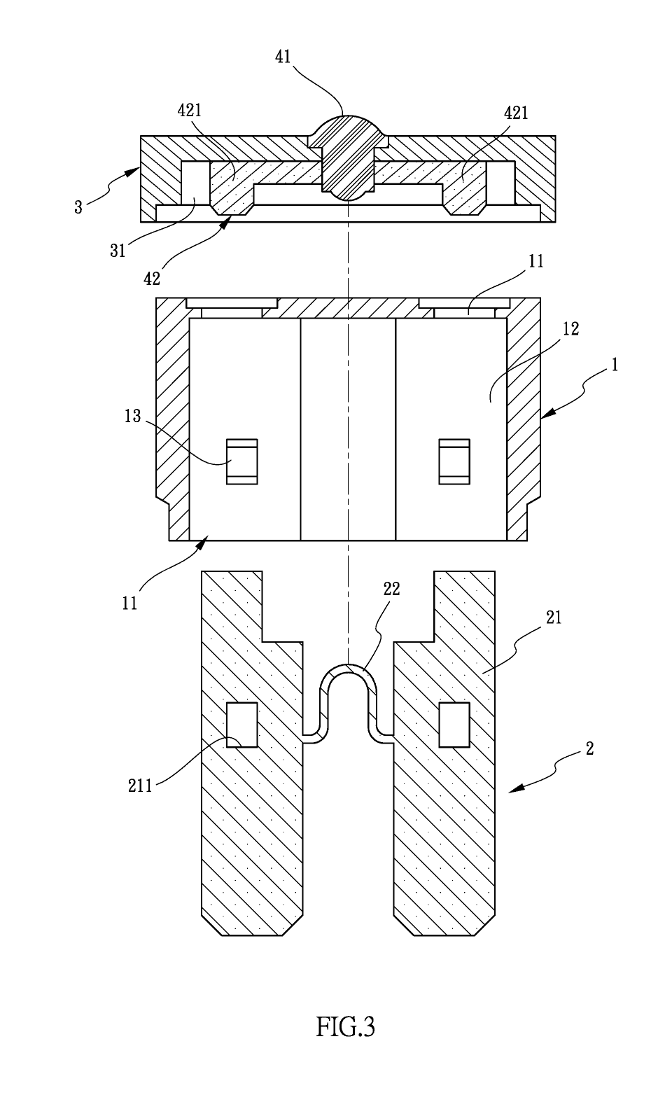

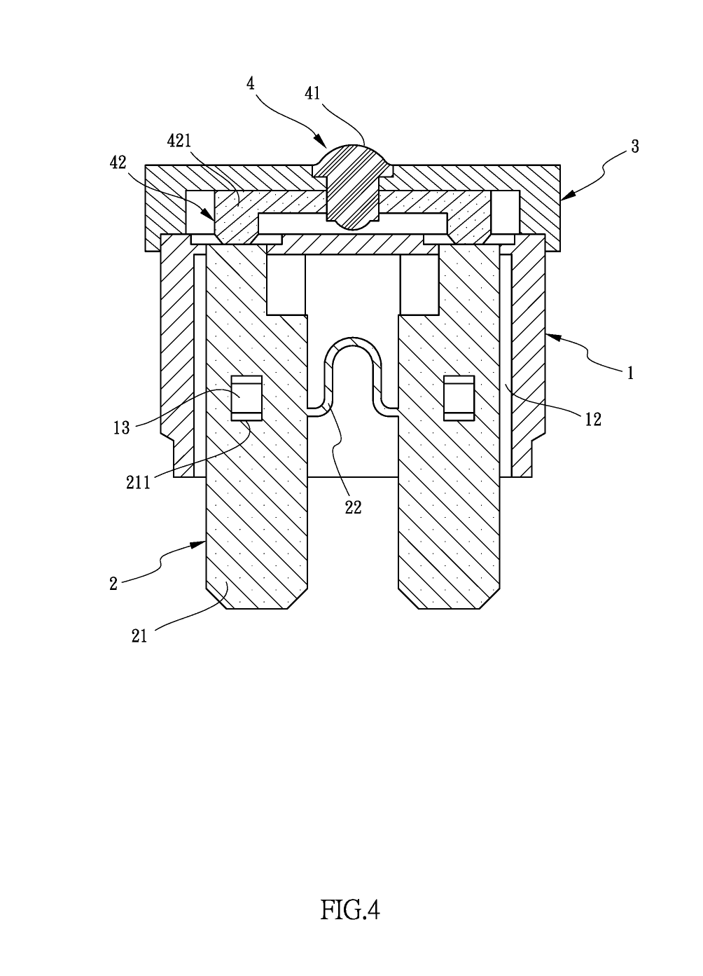

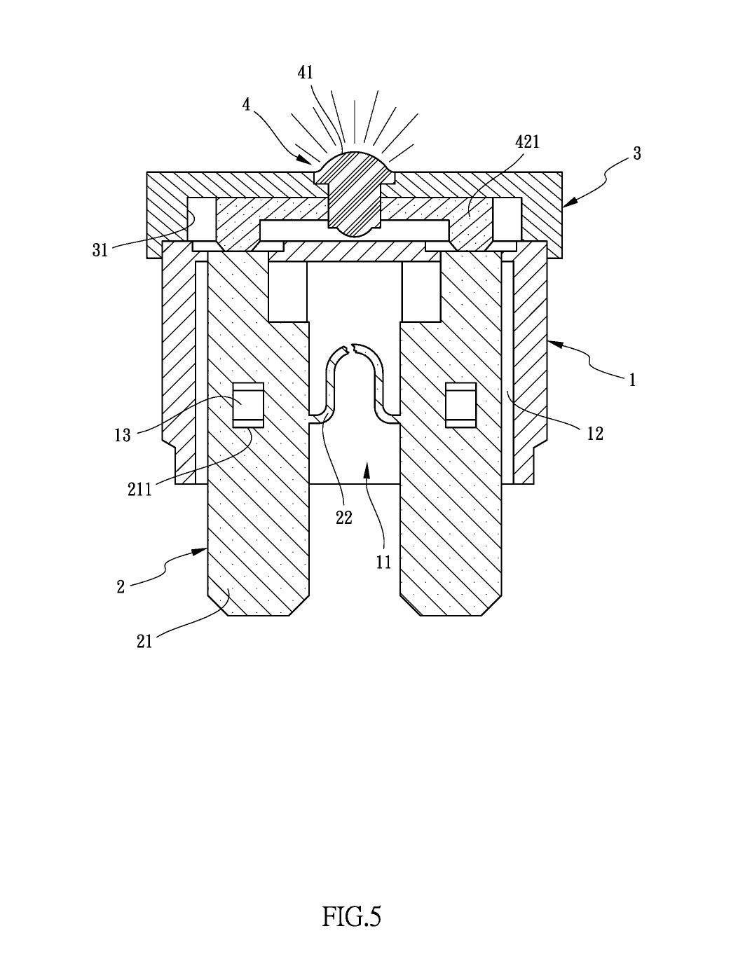

Referring to FIGS. 1 to 5, the fuse assembly of the present invention comprises a casing 1 which has two slots 11 defined through the first end thereof. A room 12 is defined in the casing 1 and communicates with the two slots 11. Two protrusions 13 extend from the inside of the room 12.

A conductive member 2 is located in the casing 1 and includes two blades 21 which are located with a gap formed therebetween. A fuse 22 is connected between the two blades 22. The first end of each of the two blades 21 extends through the correspondent second end of the casing 1.

The second end of each of the two blades 21 is located corresponding to the slot 11 corresponding thereto.

A cap 3 has an open bottom 31 and is detachably mounted to the first end of the casing 1. A light member 4 is connected to the cap 3 and has a bulb 41 and a leg portion 42 which is electrically connected to the bulb 41.

The leg portion 42 is an elongate plate which has two legs 421. The two legs 421 extend through the slots 11 and are electrically connected to the two blades 21. Each of the two blades 22 has a hole 211, and the two protrusions 13 are engaged with the two holes 211 of the two blades 22 so as to position the two blades 22 in the room 12. Preferably, the cap 3 has at least one anti-slip face 32 defined in the outside thereof.

The fuse assembly of the present invention is used for electronic parts of vehicles, and when the light member 4 lights on, this means that an abnormal current burns off the fuse 22. The light member 4 acknowledges the users to check and fix the problem. When replacing with a new fuse, the user detaches the cap 3 from the casing 1, and connects the cap 3 to a new casing 1 with a functional fuse 22. The at least one anti-slip face 32 defined in the outside of the cap 3 allows the user to grab the cap 3 easily.

Because the cap 3 with the light member 4 can be reused, and only the casing 1 is replaced, so that the light member 4 is not discarded and re-used to protect the environment from being polluted by the discarded light members. The two blades 21 of the conductive member 2 are well positioned by engaging the protrusions 13 with the holes 211 of the two blades 21, so that the two blades 21 are easily plugged to the parts cooperated with the fuse assembly.

While we have shown and described the embodiment in accordance with the present invention, it should be clear to those skilled in the art that further embodiments may be made without departing from the scope of the present invention.

1. A fuse assembly comprising:
a casing having two slots defined through a first end thereof, the casing having a room defined therein which communicates with the two slots, two protrusions extending from an inside of the room;
a conductive member located in the casing and having a first end extending through a second end of the casing, the conductive member including two blades which are located with a gap formed therebetween, a fuse connected between the two blades, each of the two blades having a hole, the two protrusions engaged with the two holes of the two blades;
a cap having an open bottom which is detachably mounted to the first end of the casing, and
a light member connected to the cap and having a bulb and a leg portion which is electrically connected to the bulb, the leg portion being electrically connected to a second end of the conductive member.

2-3. (canceled)

4. The fuse assembly as claimed in claim 1, wherein the leg portion of the light member has two legs, the leg portion is electrically connected to the bulb, the two legs extend through the slots and are electrically connected to the two blades.

5. The fuse assembly as claimed in claim 4, wherein the cap has at least one anti-slip face defined in an outside thereof.
